(19) United States
(12) Patent Application Publication
(10) Pub. No.: US 2024/0070002 A1
(43) Pub. Date: Feb. 29, 2024

(54) HANG DETECTION MODELS AND MANAGEMENT FOR HETEROGENOUS APPLICATIONS IN DISTRIBUTED ENVIRONMENTS

(71) Applicant: Oracle International Corporation, Redwood Shores, CA (US)

(72) Inventors: Nagarajan Muthukrishnan, Foster City, CA (US); Ravi Shankar Thammaiah, Redwood City, CA (US); Raja Narasingarao, Tamil Nadu (IN); Manoj Dhanapal, San Mateo, CA (US); Sumanta Kumar Chatterjee, Menlo Park, CA (US); Binoy Sukumaran, Foster City, CA (US)

(73) Assignee: Oracle International Corporation, Redwood Shores, CA (US)

(21) Appl. No.: 17/894,322

(22) Filed: Aug. 24, 2022

(51) Int. Cl. G06F 11/07; G06F 9/48; G06F 9/50

(52) U.S. Cl. CPC G06F 11/0754; G06F 9/4881; G06F 9/5077

(57) ABSTRACT

Techniques described herein include frameworks and models for identifying, analyzing, and addressing hangs within distributed and heterogenous computing environments. A hang detection framework may model a distributed computing environment as a complex forest of interrelated requests. The hang detection framework may generate hang graphs based upon requests that are being processed and/or waited upon within the distributed environment. For example, a node within an acyclic graph may represent an execution entity that is currently processing one or more requests. Directed edges that connect one node to another may represent requests upon which an execution entity is waiting for another execution node to fulfill. The model may be used to isolate and address the root cause of hangs within the computing environment.

### TECHNICAL FIELD

The present disclosure relates to hang detection, analysis, and management. In particular, the present disclosure relates to a framework and model for mitigating the impact of unresponsive resources in distributed computing environments.

### BACKGROUND

In large scale and distributed computing environments, numerous computing resources execute various data and control plane operations. For example, an autonomous cloud service may simultaneously process multiple client requests to allocate and manage cloud resources, where processing an individual client request includes the coordination and execution of a sequence of tasks by multiple applications, web servers, databases, and/or other computing resources across different computing domains. Clients often expect requests to be served within a well-bound timeframe. However, stalls and hangs within the underlying computing resources may significantly impact the duration of responding to client requests and, in some cases, may result in a failure to properly carry out the requested operation.

There are various potential causes of stalls and hangs within complex computing environments. Examples include software bugs causing runtime execution errors, surges in requests overloading system resources, conflicting resource dependencies leading to deadlocks, and hardware issues affecting the operations of the software stack. In many cases, a stall when responding to one client request may cascade and negatively affect response times to other requests, which may be exacerbated if the cause of the stall is not promptly addressed.

One approach to detecting and mitigating the effects of hangs is to implement timeout thresholds for various operations. If an operation does not complete within a predefined threshold timeframe, then the operation may be aborted, thereby preventing hangs from indefinitely holding up client requests. However, in most cases, this approach does not identify or resolve the root cause of a hang and may fail to prevent the problem from cascading from one node to another within the system. In large scale and distributed environments, the execution node or set of execution nodes causing a hang is often not readily apparent and may be difficult to isolate.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example system architecture in accordance with some embodiments;

FIG. 2 illustrates an example set of operations for registering execution entities with a hang management system in accordance with some embodiments;

FIG. 3 illustrates an example set of operations for generating and publishing hang graphs in accordance with some embodiments;

FIG. 4 illustrates an example hang graph in accordance with some embodiments;

FIG. 5 illustrates an example set of operations for resolving hangs based on a hang graph in accordance with some embodiments; and

FIG. 6 shows a block diagram that illustrates a computer system in accordance with some embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. GENERAL OVERVIEW

Complex computing environments may include numerous heterogenous resources for processing and serving requests. For example, a heterogenous cloud environment may include multiple hardware processors, operating systems, application instances, web servers, databases, storage servers, network connections, user sessions, and/or other computing resources. Many computing resources within the environment may be geographically dispersed and connected by a network. Given the vast number and distributed nature of resources involved in serving requests, quickly isolating and addressing the root cause of hangs is often not feasible for an administrator to perform manually. The failure to promptly respond to a hang may cause the problem to cascade to other interconnected components, significantly degrading system performance and increasing client response times.

Embodiments described herein include frameworks and models for identifying, analyzing, and addressing hangs within distributed computing environments. A hang detection framework may model a distributed computing environment as a complex forest of distributed acyclic graphs. The hang detection framework may generate the acyclic graphs based upon the requests that are being processed and/or waited upon within the distributed environment. For example, a node within an acyclic graph may represent an execution entity that is currently processing one or more requests. Directed edges that connect one node to another may represent requests upon which an execution entity is waiting for another execution node to fulfill. Thus, an acyclic graph may model a chain of interrelated requests for an execution flow within the distributed environment.

In some embodiments, the hang detection framework builds the acyclic graphs by registering and collecting information from execution entities. When an execution entity comes online, the execution entity may implement a registration protocol to register with the hang detection framework. If the execution entity does not support the protocol defined by the model, then the hang detection framework may register an adapter for the execution entity. Once registered, the hang detection framework may periodically receive information from the execution entities or associated adapters including: (a) information about the requests the node is currently serving, and/or (b) information about the requests on which the node is currently waiting. Based on the information, the hang detection framework may identify one or more chains of interrelated requests and build one or more directed acyclic hang graphs. The hang detection framework may traverse the chain of interrelated requests captured by the hang graphs to identify which execution nodes are causing hangs and which execution flows are affected by the hangs.

In some embodiments, a hang resolution framework performs operations based on the identified source causing a hang and the hang graph(s) of execution flows affected by the source of the hang. Example operations may include notifying execution entities along the chain of interrelated requests within one or more hang graphs, generating incident reports to notify administrators about the source of the hang and/or about affected execution flows/nodes, terminating or restarting stalled nodes, and redirecting requests from unresponsive execution entities to other execution entities. Additionally or alternatively, execution entities may implement node-specific hang management resolution operations when notified by the hang management framework of a hang affecting pending requests associated with the execution entity. For example, a database system that is waiting on a storage server to fulfill a request to allocate a new tablespace may be notified by the hang management system that the storage server is unresponsive. In response, the database system may send another request to the same storage server to retry the operation, send a request to a redundant storage server to allocate the tablespace using a different server, return an error message to an upstream node in the execution flow to abort the operation, or perform one or more other node-specific hang resolution operations. Thus, an execution entity may use published hang graph information to determine which hang resolution operations to execute, if any.

One or more embodiments described in this Specification and/or recited in the claims may not be included in this General Overview section.

### 2. SYSTEM ARCHITECTURE

Embodiments described herein may be implemented within distributed and/or heterogenous computing environments comprising various hardware and software resources. In a distributed environment, applications and databases may be executed in a distributed nature on different network host machines and servers, which may be geographically dispersed. A distributed environment may provide high availability whereby clients may submit requests at any time of day from varying locations and receive responses, even if not every single component within the computing environment is operational.

Heterogenous computing environments may include a mix of various types of computing resources. For example, the computing environment may include heterogenous applications, which may originate from different vendors, operate on different file formats, implement different application-specific functions, and/or expose different application programming interfaces (APIs). As another example, the computing environment may include various kinds of processors or processing cores that implement different instruction set architectures (ISAs). Additionally or alternatively, the heterogenous environment may comprise a mix of other types of computing resources, such as execution entities operating on different operating systems and/or different server architectures. Heterogenous computing environments provide flexibility in the resources that are deployed within the environment, the composition of which may evolve over time.

Additionally or alternatively, embodiments described herein may be implemented by computing environments that process client requests using a plurality of tiers or layers. Each tier or layer of a multi-tier architecture represents a distinct logical and/or physical element that is responsible for a different set of functions. The number and configuration of tiers within a multi-tier architecture may vary, depending on the particular implementation. For instance, a three-tier system may include a presentation tier comprising logic for displaying and/or receiving information, an application tier comprising heterogenous applications for implementing application-specific functions, and a data tier comprising logic for storing and retrieving data. In other examples, the multi-tier architecture may include, in addition or alternatively to the tiers previously listed, a web tier comprising logic for processing web requests, a middleware tier comprising logic to connect other tiers within the architecture, and/or other tiers comprising one or more computing resources to execute tier-specific functions. Hangs that occur within one tier may affect the responsiveness of resources within the same tier or other tiers. The hang detection and management frameworks, described further herein, may detect which tiers are the source of hangs and the impact on other tiers within the multi-tier architecture.

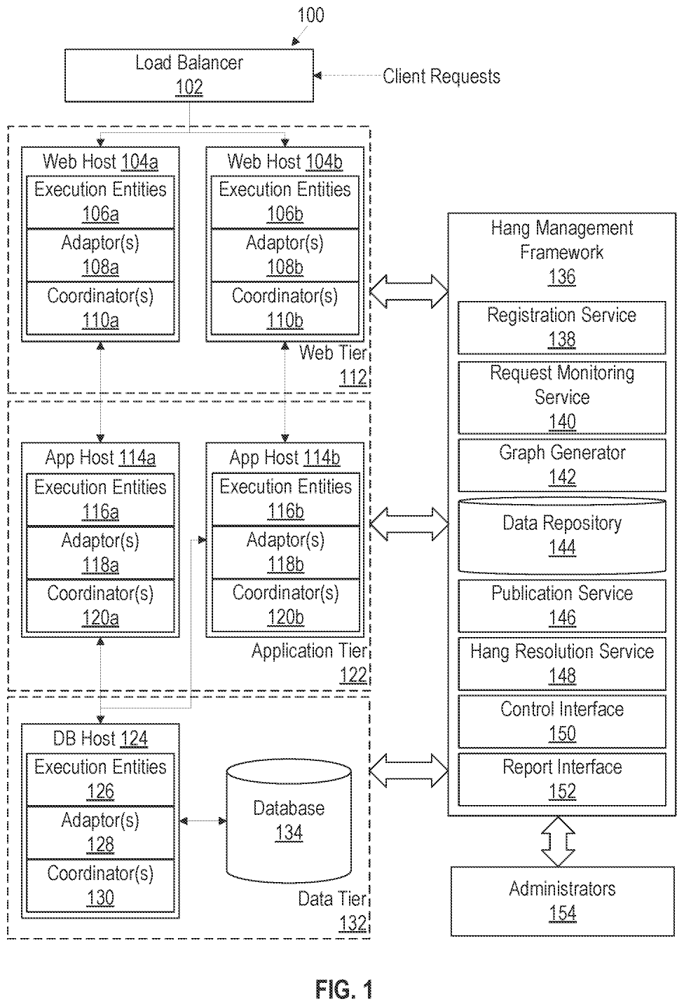

FIG. 1 illustrates an example system architecture in accordance with some embodiments. As illustrated in FIG. 1, system 100 includes hang management framework 136 for detecting and resolving hangs within a heterogenous computing environment. In other embodiments, system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In some embodiments, hang management framework 136 may manage hang detection and resolution operations for resources deployed across different tiers including web tier 112, application tier 122, and data tier 132. With reference to the multi-tier environment, client requests are received at load balancer 102. In response, load balancer 102 routes the request to one of web host 104a or web host 104b, which include execution entities 106a and 106b, respectively, for processing the inbound requests. Application (App) hosts 114a and 114b include execution entities 116a and 116b, respectively, to provide application-specific functions for processing the requests, and, database (DB) host 124 includes execution entities to manage storage and retrieval of information from database 134. Although a particular topology of the multi-tier application is depicted, the actual topology of the application monitored by hang management framework 136 may vary from implementation to implementation. The application may include additional or fewer tiers and target resources. Further, the topology of the multi-tier application may change over time with the addition, removal, and/or update of target resources.

An execution entity or node may refer to a set of one or more hardware and/or software resources that perform an action based on a request. Examples include application instances executing application-specific functions, operating systems allocating resources for an application, representational state transfer (REST) endpoints serving client requests, and database instances responding to queries. However, the types of execution entities may vary depending on the system architecture, topology, and requests being processed.

Execution entities may be classified as sources and/or targets. An execution entity that sends a request to another entity is the source of the request, and the execution entity receiving the request is the target. A target may also be a source when the execution entity has also initiated requests to other execution entities. For instance, a source application or endpoint may initiate an execution flow by calling a target application or endpoint. To process the request, the target application or endpoint may be the source of one or more downstream requests to other applications or endpoints.

In some embodiments, execution entities implement a protocol to register and communicate with hang management framework 136. For example, when an execution entity first comes online, the execution entity may send a notification message to hang management framework 136 to initiate the registration process, which is described in further detail below in Section 3, titled Registering Execution Entities for Hang Management. Some execution entities, such as legacy software applications and endpoints, may not natively support the registration protocol. To accommodate these sources and targets, adaptors 108a, 108b, 118a, 118b, and/or 128 may be deployed within the environment. An adaptor is an entity that converts information from a source and/or target to a format consumable by hang management framework 136. Adaptors allow hang management framework 136 to extract and operate on information from an execution entity without requiring any modification to the underlying software and/or hardware.

In some embodiments, system 100 includes coordinators 110a, 110b, 120a, 120b, and 130. Coordinators are entities that coordinate the extraction of information by adaptors. For example, coordinators may detect computing resources on a host that are not able to communicate directly with hang management framework 136 and instantiate adaptors to extract request information on behalf of the resource. The adaptor that is selected and instantiated by the coordinator may depend on the type of computing resource that is registered with and linked to the adaptor. Different adaptors may include code and/or other logic to extract request information for different types of resources. The request information may be stored in varying file types, formats, locations and/or structures depending on the type and configuration of the resource. The coordinators may maintain a pool of adaptors that are able to operate on and process log records, datafiles, and/or other sources or request information for a variety of computing resources, which may span different tiers of an application, include different releases or versions of a resource, and/or include resources from different vendors.

Hang management framework 136 includes a set of components for performing hang detection, analysis, and resolution. In some embodiments, the components include registration service 138, request monitoring service 140, graph generator 142, graph repository 144, publication service 146, hang resolution service 148, report interface 150, and control interface 152. As previously noted, the combination of components of system 100, including hang management framework 136, may vary depending on the particular implementation.

Registration service 138 registers execution entities of the heterogenous computing environment with hang management framework 136. Registration service 138 may process registration requests received from execution entities that support a registration protocol. Additionally or alternatively, registration service 138 may (a) detect execution entities that have not registered and/or (b) configure adaptors if the execution entities do not natively support a protocol for providing request information to hang management framework 136.

Request monitoring service 140 periodically extracts current request information from execution entities 106a, 106b, 116a, 116b, and 126. For nodes that adhere to the protocol defined by the model, the execution entities may send the information directly to request monitoring service 140. For nodes that do not implement the protocol, the information may be extracted by an adaptor linked to the execution entity.

Graph generator 142 generates directed acyclic hang graphs based on the received request information. Example techniques for generating hang graphs are described further below in Section 4, titled Hang Detection and Analysis.

Data repository 144 stores data objects generated by one or more components of hang management framework 136. For example, data repository 144 may store hang graphs and/or information about current requests. Data repository 144 may be any type of storage unit and/or device (e.g., a file system, database, collection of tables, or any other storage mechanism) for storing the hang management and graph data. Further, data repository 144 may include multiple different storage units and/or devices. The multiple different storage units and/or devices may or may not be of the same type or located at the same physical site. Further, data repository 144 may be implemented or executed on the same computing system as one or more other components of system 100. Alternatively or additionally, data repository 144 may be implemented or executed on a computing system separate from one or more other components of system 100. When remotely implemented, data repository 144 may be communicatively coupled to via a direct connection or via a network.

Publication service 146 publishes hang graphs and/or other hang information to one or more nodes within system 100. For example, publication service 146 may send a hang graph to one or more execution entities that are affected by a hang, which may be determined based on which execution entities are sources or targets in a chain of interrelated requests captured by the graph. Hang graphs may be published to allow for distributed monitoring and mitigation of stalled execution flows. Additionally or alternatively, publication service 146 may publish hang graphs to other channels, such as through a web interface accessible by administrators 154.

Hang resolution service 148 identifies the source of hangs based on the generated hang graphs. Hang resolution service 148 may trigger one or more actions to resolve the hangs based on the identified source. Example actions may include node sniping to shutdown or restart individual nodes that are causing a hang, notifying upstream nodes in an execution flow of the hang, deploying patches to update a node, changing configuration settings on the node, and redirecting requests within an execution flow.

Control interface 150 includes hardware and/or software through which hang management framework 136 interacts with execution entities 106a, 106b, 116a, 116b, and 126. For example, control interface 150 may comprise an application programing interface (API) and/or a messaging interface through which commands are directed to configure and control execution entities, adaptors, and/or other nodes within the heterogenous computing environment. Additionally or alternatively, control interface 150 may include an API through which one or more components of hang management framework 136 may be invoked.

Report interface 152 includes hardware and/or software for triggering alert notifications and reports when hangs are detected. In some embodiments, administrators 154 register via report interface 152 to receive alert notifications. Administrators 154 may input contact information such as an email address, short message service (SMS) number, and/or social media handle. Report interface 152 may send alerts and/or reports using the contact information to notify administrators when hangs are detected. The reports may include published hang graphs, information about the root cause of a hang, and/or recommended actions to perform to resolve a hang. The reports may help administrators 154 quickly isolate and address problematic resources that are causing hangs and degrading system performance.

Although hang management framework 136 is illustrated as a single, centralized service, hang management framework 136 may be distributed across multiple nodes within a distributed environment. In some embodiments, one or more components of hang management framework 136 may execute in a cluster, with different instances of the components executing on separate hosts. For example, registration service 138 may execute on different hosts. An instance of registration service 138 executing on a particular host may register resources that are local to the host. Different instances of registration service 138 may share the local registration data to create a global registry of execution entities within the distributed environment.

In some embodiments, graph generator 142 executes in a distributed manner, with instances of graph generator 142 executing on separate hosts and building local graphs on a per-host basis. A local graph may capture a chain of interrelated requests for resources executing on the same host machine or a cluster of related host machines. For example, the graph may capture requests between applications, operating systems, databases, network endpoints, and/or other types of computing resources on the host or set of clustered hosts.

A global graph generator may combine multiple local graphs from different hosts (or different clusters of hosts) based on detected relationships from the request information associated with the hosts. For instance, a local graph on an application server may be linked to one or more local graphs on one or more database servers based on database queries issued by an application endpoint on the application server to one or more database endpoints on the one or more database servers. The graphs may be updated as the topology of the distributed environment and/or the execution flows processed therein change over time.

In some embodiments, one or more components of system 100, such as hang management framework 136, may be implemented as a cloud service. For instance, system 100 may be implemented in a platform-as-a-service (PaaS) that allows multiple subscribers of the cloud service to share resources for building and hosting web-based applications. As another example, hang management framework 136 may be implemented in a software-as-a-service (SaaS) to analyze hangs within a subscriber's environment. Additional embodiments and/or examples relating to computer networks are described below in Section 7, titled Computer Networks and Cloud Networks.

### 3. REGISTERING EXECUTION ENTITIES FOR HANG MANAGEMENT

In some embodiments, execution entities or nodes register with hang management framework 136 when the execution entities come online or at other points in time when the execution entity is running. During the registration process, hang management framework 136 may receive information about the execution entity and store the registration data in a table or other data structure. The registered information may be used to perform hang detection and resolution operations as described further herein. The registration process may be initiated by the execution entities, such as by issuing a registration request to registration service 138 or may be initiated by hang management framework 136 upon detecting an execution entity.

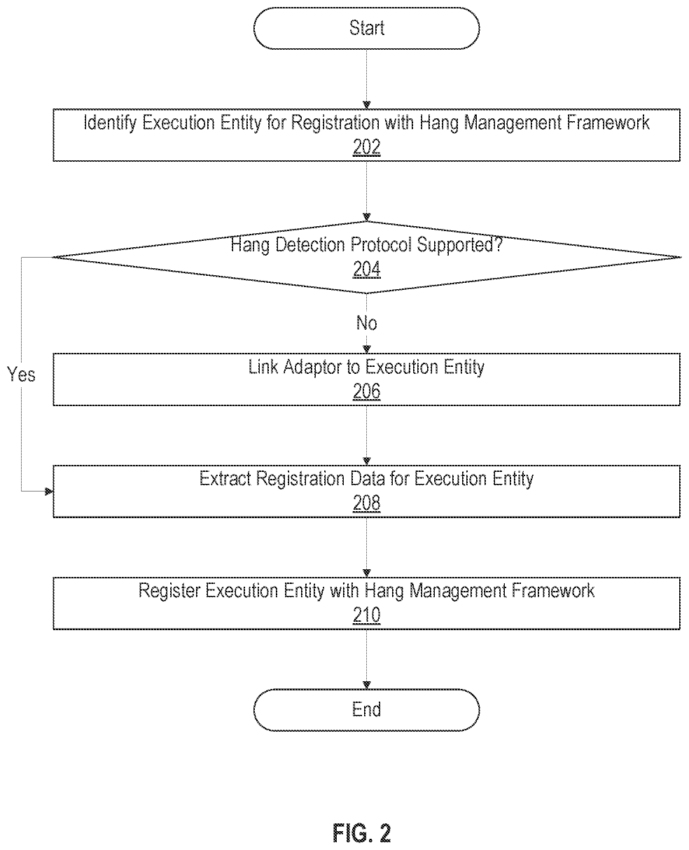

FIG. 2 illustrates an example set of operations for registering execution entities with a hang management system in accordance with some embodiments. One or more operations illustrated in FIG. 2 may be modified, rearranged, or omitted all together. Accordingly, the particular sequence of operations illustrated in FIG. 2 should not be construed as limiting the scope of one or more embodiments.

In operation 202, registration service 138 identifies an execution entity for registration with hang management framework 136. In some embodiments, registration service 138 identifies the node responsive to receiving a registration request from the execution entity. In other embodiments, registration service 138 may identify the execution entity without receiving a request, such as by scanning a list of resources that are currently online within the heterogenous environment or analyzing system communications and request information to determine which resources are currently operational within a host.

In operation 204, registration service 138 determines whether the execution entity supports the hang detection protocol. Execution entities that adhere to the model protocol may indicate that the protocol is supported in the initial registration request or responsive to being queried by registration service 138. If the execution entity does not respond to communications adhering to the protocol, then registration service 138 may infer that the execution entity does not adhere to the protocol.

In operation 206, registration service 138 links an adaptor to the execution entity if the execution entity does not adhere to the hang detection protocol. In some embodiments, linking the adaptor includes configuring the adaptor to communicate with hang management framework 136 on behalf of the execution entity. Adaptor service 140 may configure the adaptor to scan log files, standard query language (SQL) interfaces, datafiles, and/or other sources that include information about what requests the execution entity is currently processing.

The source of the request information may vary depending on the type of execution entity being linked to the adaptor. For example, a database instance may store request information in different directories, log locations, and/or file formats than a network socket endpoint. As another example different versions of a resource, such as an operating system or application, or resources from different vendors may store information in different root directories and formats.

In some embodiments, hang management framework 136 includes different adaptors to accommodate different types of computing resources that do not support the registration protocol. Different adaptors may include different source code and logic for extracting request information for linked resources. For example, an adaptor linked to a database instance may be configured to scan different sources than an adaptor linked to a socket entity. The adaptor linked to the database instance may include an endpoint that interfaces with the database instance to identify a directory where database logs are stored. In other cases, the adaptor may not directly interface with the database instance, but search for log files and/or other filetypes that are associated with the database instance. The adaptor may parse identified log files in accordance with a format that may be specific to the particular database. For instance, the adaptor may analyze the log files for particular keywords or metadata tags indicative of stored request information, log file locations where requests are known to be stored, and/or other storage patterns to identify request information stored within a set of log files associated with the database. The adaptor linked to the socket entity may similarly be configured to analyze different filetypes, formats, and/or patterns that are specific to the socket entity. Additionally or alternatively, hang management framework 136 may include adaptors for different versions of a computing resource, such as different releases of a database system or database systems from different vendors.

In some embodiments, coordinators 110a, 110b, 120a, 120b, and 130 detect resources that have not registered with hang management framework 136 and instantiate adaptors for these resources. A coordinator may select a particular adaptor from a set of available adaptors based on the type of computing resource (also referred to as “target type”) that is being registered. Examples of target types include hosts, databases, application servers, applications, listeners, load balancers, REST endpoints, user sessions, and network sockets. Additionally or alternatively, a target may include other types of computing resources. Hang management framework may map each target type to one or more adaptors.

In some embodiments, a given target type may be mapped to multiple adaptors. For instance, a database target type may be mapped to a set of adaptors that vary depending on the name, vendor, release version, and/or other attributes of the particular database. At runtime, a coordinator may identify the set of attributes and which adaptor has been mapped to the set of identified attributes. The coordinator may then instantiate the identified adaptor to execute on the same host as the target and extract request information on behalf of the resource. The coordinator may configure the instance of the adaptor based on a set of attributes associated with the resource. For instance, the coordinator may configure the adaptor to scan a particular root directory for log records with a particular file extension or embedded metadata tag associated with the resource.

In some embodiments, hang management framework 136 may not include an adaptor for a particular resource that is deployed within the distributed environment. This scenario may occur if the set of adaptors does not include code or logic for extracting request information for the target type or for a particular implementation of the target type, such as a particular version of a database or databases from a particular vendor. Additionally or alternatively, some resources may not log request information, and an adaptor may not be able to extract this information from the resource. For these resources, hang management framework 136 may infer registration and/or request information as described further herein without instantiating an adaptor for the resource.

In operation 208, registration service 138 extracts registration data for the execution entity. In some embodiments, the registration data for a source or target entity may include one or more of the attributes illustrated in Table 1.

TABLE 1
Example registration data for sources and targets

| Attribute | Attribute Description |
|---|---|
| name | A hostname or generic name for an execution |
| | entity |
| group | A group description associated with the |
| | execution entity such as a common name for |
| | multiple instances of the same application |
| Id | A unique identifier for the execution entity |
| | within the execution entity |
| description | A general description for the entity |
| target type | A value identifying what type of resource the |
| | execution entity is |

Additionally or alternatively, the registration data may include one or more additional attributes and/or omit one or more of the attributes listed in Table 1, depending on the particular implementation. Execution entities that adhere to the model protocol may send one or more messages to registration service 138 that include the attributes. For entities that do not adhere to the protocol, the adaptors may extract the attributes from log records and/or other files associated with the linked target resource.

If a resource does not support the registration protocol and is not linked to an adaptor, then one or more attributes may be inferred based on requests and execution flows within the distributed environment. In some embodiments, registration service 138 may extract one or more registration attributes from orphan requests, which are described further below. For instance, registration service 138 may infer the hostname, group, resource identifier, description, target type, and/or other attributes for a resource based on requests submitted to the resource by other resources. Some attributes, such as a hostname, may be extracted directly from request logs. Additionally or alternatively, some attributes may be inferred based on the format and/or other attributes of the request. As an example, registration service 138 may infer that a request that includes a SQL statement for execution is made to a database instance. Thus, registration service 138 may populate the registration information for the execution entity with attributes inferred or otherwise extracted from request logs of other resources within the distributed environment.

In operation 210, registration service 138 registers the execution entity with hang management framework 136. Registration service 138 may store the registration data within data repository 144, which may include a list of registered execution entities and a mapping between the execution entities and the set of attributes registered to the entity. Hang management framework 136 may periodically extract request information from the registered entities as described further below.

### 4. HANG DETECTION AND ANALYSIS

In some embodiments, hang management framework 136 tracks chains of interrelated requests for one or more execution flows associated with the set of registered execution entities. Hang management framework 136 may construct directed acyclic hang graphs based on request information extracted from the registered entities. Hang management framework 136 and/or other entities may analyze the hang graphs to isolate which execution nodes are causing a stall in an execution flow and determine the underlying reasons for the stall.

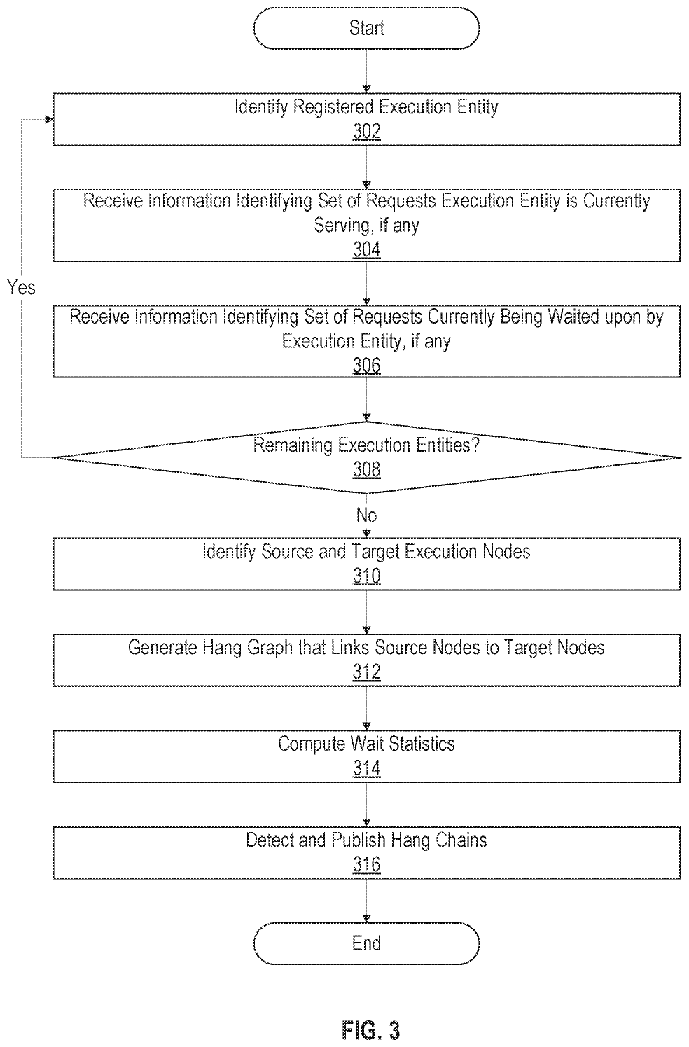

FIG. 3 illustrates an example set of operations for generating and publishing hang graphs in accordance with some embodiments. One or more operations illustrated in FIG. 3 may be modified, rearranged, or omitted all together. Accordingly, the particular sequence of operations illustrated in FIG. 3 should not be construed as limiting the scope of one or more embodiments.

In operation 302, request monitoring service 140 identifies a registered execution entity. In some embodiments, request monitoring service 140 iterates through a list of registered execution entities stored in data repository 144. Request monitoring service 140 may periodically iterate through the execution entities or execute the process on demand.

In operation 304, request monitoring service 140 receives information identifying a set of requests the execution entity is serving, if any. If the execution entity adheres to the model protocol, then the execution entity may send a message conforming to the protocol that includes the request information. If the execution entity does not adhere to the protocol, then request monitoring service 140 may interface with a linked adaptor and/or adaptor coordinator to extract the information about current requests being served. An adaptor coordinator may instantiate a new instance of an adaptor responsive to the request if one is not already executing within a host. As previously noted, the adaptor may scan log records and/or other sources to extract the information.

In operation 306, request monitoring service 140 receives information identifying a set of requests currently being waited upon by the execution entity, if any. As with the first set of requests, request monitoring service 140 may receive the information about the new type of requests directly from execution entities adhering to the protocol or from adaptors linked to the execution entities.

In some embodiments, the hang management protocol specifies a set of attributes, such as those depicted in Table 2, to characterize the set of requests.

TABLE 2
Example request information

| Attribute | Attribute Description |
|---|---|
| description | A general description of the request |
| id | A unique identifier representing the request |
| type | A type of request being served or waited upon |
| reason [1, 2, . . . n] | A set of n reasons associated with the request, |
| | which may include arguments submitted with |
| | the request or response types expected for the |
| | request |
| wait_class | A classification for a request being waited |
| | upon that indicates a reason or type for the |
| | wait |
| progress | A progress indicator representing how much |
| | progress has been made processing the |
| | request |

Additionally or alternatively, the request data may include one or more additional attributes and/or omit one or more of the attributes listed in Table 2, depending on the particular implementation.

The wait class attribute may be useful to analyze what is causing an execution node to wait on a request. Example wait class values are depicted in Table 3 below.

TABLE 3
Example wait class values

| Wait Class Value | Value Description |
|---|---|
| wait | A source is currently blocked on the request |
| async_wait | A source is currently waiting for the request |
| | but is not blocked and may be performing |
| | another request |

The different wait class values illustrated above indicate whether a source is blocked or not. A source that is blocked may be much more likely to cause a stall that propagates to multiple execution flows. In addition or as an alternative to the wait classes depicted in Table 3, other wait class values may be defined, depending on the particular implementation.

Wait class values may further vary for different types of resource requests and/or target types. For instance, requests issued to database applications may have a different set of wait class values then requests issued to middleware applications and web applications. The wait class values for databases applications may reflect database-specific causes and reasons for hangs that are unique to database, such as query execution hangs and/or database-specific deadlocks. Similarly, wait class values for other types of resources may include values that are specific to the target type, product, and/or release version. Thus, the wait class attribute may reflect different wait classifications associated with the different types of requests. Different actions may be triggered within the hang management system based on the type of wait class values associated with the source of a hang, as described further below.

In operation 308, request monitoring service 140 determines whether there are any remaining execution entities to analyze. If so, then the process returns to operation 302 and iterates until request information has been extracted for each registered execution entity that is online.

In operation 310, graph generator 142 identifies source and target execution nodes 310 that are related based on the request information. A source associated with a request may be identified based on which execution entity submitted the request, and a target may be identified based on which execution entity was called by the request. Multiple requests may be sent to the same target or different targets. By analyzing the extracted request information, graph generator 142 may identify a chain or forest of interrelated requests.

In operation 312, graph generator 142 generates a hang graph linking source nodes to related target nodes. In some embodiments, the hang graph is an acyclic directed graph, where a node within the graph represents a source or target of a request. Directed edges may connect source nodes with related target nodes to represent requests upon which the sources are waiting for the targets to fulfill. The nodes and/or edges of the graph may be linked to request attributes, such as the attributes in Table 2, to provide information about requests currently being served and waited upon by execution nodes represented in the graph.

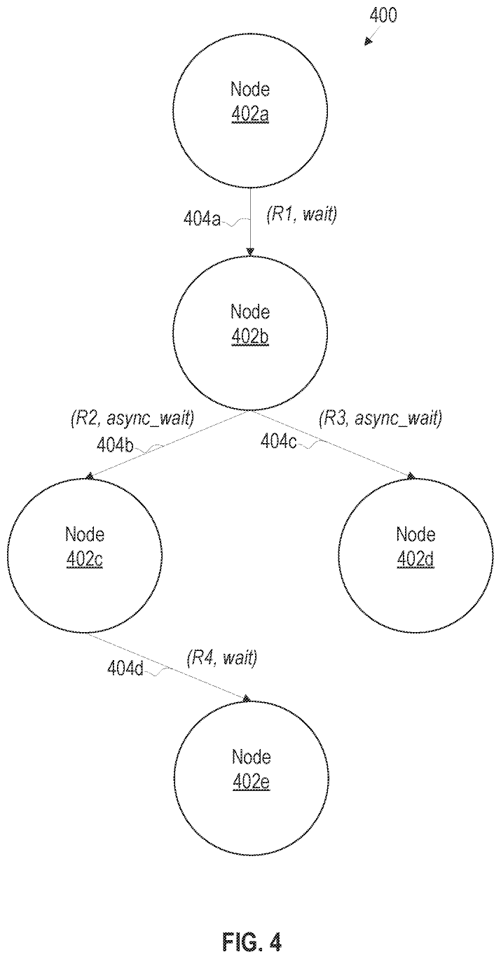

FIG. 4 illustrates an example hang graph in accordance with some embodiments. Hang graph 400 includes nodes 402a-e representing different sources and targets of requests. Directed edges 404a-d represent requests that link source and target nodes together. For example, directed edge 404a links nodes 402a and 402b, where node 402a is the source of the request and node 402b is the target of the request. Node 402b is the source of two other requests, with nodes 402c and 402d being the target as indicated by directed edge 404b and 404c, respectively. It is noted that the number of nodes and connection of nodes may be much greater than illustrated and vary from one execution flow to the next. Accordingly, components and/or operations described herein should be understood as a specific example which may not be applicable to certain embodiments.

In some embodiments, hang graph 400 stores information about the execution entities and interrelated requests. For example, for each of nodes 402a-e, hang graph 400 may store and link to one or more attributes illustrated in Table 1 and attributes in Table 2 for the requests that the node is currently serving. Additionally or alternatively, directed edges 404a-d may include information about the requests linking the nodes, including a wait class such as illustrated in Table 3 and/or other request attributes. As previously noted, the wait classifications may vary depending on the type of request and/or execution entities serving the request.

In some embodiments, hang graph 400 may be presented visually through a graphical user interface (GUI), such as through a webpage or page of an application. The interactive interface may allow a user to select nodes to drill down on the specific attributes of an execution entity and/or request captured by hang graph 400. For example, responsive to a user clicking on a user interface element representing node 402a, the source attributes and/or request attributes being served by the source may be presented in the same or separate page of the GUI.

Additionally or alternatively, hang graph 400 may be generated in a format that is consumable by other applications or services. For example, hang graph 400 may be stored in a file that conforms to a particular file format, such as a markup language file format that encodes the node relationships and interrelated request information. Applications and services may operate on the file to perform additional operations such as training machine learning models to detect and predict patterns within a hang chain, triggering operations to resolve hangs within an execution flow, and executing analytic operations to provide insights into the causes and effects of hangs and/or the results of various hang resolution operations.

Referring again to FIG. 3, in operation 314, the process computes wait statistics for the hang graph. Wait statistics may be computed per individual request, per groups of interrelated requests, and/or per execution flow. For example, the process may determine how long node 402b has been waiting on request R2 and request R3. The process may sum the wait times to compute a total wait time for the execution flow. The process may further monitor how much progress has been made between sample intervals based on the progress indicators. The wait statistics may be added to the hang graph and monitored to detect hangs.

To compute wait statistics, the process may analyze timestamps associated with the extracted request information. For example, registered execution entities that support the hang management protocol may provide a timestamp for each request that identifies a start time when the request was initiated. Adaptors linked to execution entities that do not support the protocol may extract the timestamp from request logs and provide the information to hang management framework 136. The process may compute the wait time for a request by taking the difference between a current time and the start time associated with the request. The computed wait value may be stored for a corresponding node connection within the graph and/or aggregated with other wait values.

Wait values may be aggregated across execution flows, as previously described, and/or across registration attributes. In some embodiments, wait values may be aggregated by target type and/or request type. For example, wait values may be aggregated for all requests being waited upon by operating systems within the distributed environment. As another example, wait values may be aggregated for all requests currently being served by database instances within the distributed environment.

Additionally or alternatively, wait values may be aggregated across other dimensions. For example, wait values may be aggregated across all execution entities on a particular host or for requests with a particular wait classification. In some embodiments, dimensions may be specified in queries that are executed against the hang graph. A query result may be generated by grouping and summing or otherwise aggregating wait values by the dimensional attributes specified in the query. Thus, the system may provide flexibility in analyzing and comparing wait values across various dimensions.

In operation 316, publication service 146 detects and publishes hang chains. In some embodiments, publication service 146 sends the hang graph to execution entities that adhere to the hang management protocol that have registered with hang management framework 136. Additionally or alternatively, publication service 146 may send the hang graph to adaptors linked to execution entities that do not adhere to the protocol. Publication service 146 may restrict publication to execution entities in the chain or may send the hang chain to all the execution nodes that have registered. The published hang graph may include the information about the execution entities, such as hostname and target type, the requests currently being served by each execution entity, and the requests being waited upon by each execution entity. The execution entities may use the published hang graph to detect hangs and determine whether to take corrective actions to address the root cause of a hang.

As previously noted, hang chains may be generated locally and/or globally within the distributed environment. A local hang chain may model requests within a single host or a cluster of related hosts. Global hang chains may be generated by linking two or more local hang chains. To generate a global hang chain, the process above may be executed on a set of hosts within the distributed environment. The local hang chains may be published to each other or a centralized node, which may determine connections between the local hang chains, if any, and link the chains together. A connection may be detected when a request originates from a resource on one host and targets a resource on another host. In this case, the request corresponds to an edge that connects a first node of a graph local to the source host to a second node of a graph local to the target host.

In some embodiments, hang chains within a hang graph are detected based on one or more wait statistics. Different approaches may be implemented to classify hangs. As an example, a hang may be detected if execution of a set of operations in an execution flow has exceeded a threshold timeframe. As another example, a hang may be detected if progress with respect to a request has not increased within a threshold timeframe. The process may traverse the hang graph to determine which chain of interrelated requests are causing the stall and which execution entities are affected by the stall. Publication service 146 may then publish the hang graph to these entities or linked adaptors.

In some embodiments, classifying a hang may vary based on the target types and/or wait classifications in a set of requests associated with an execution flow. For example, a threshold wait value for detecting a hang in an execution flow may be adjusted upward or downward based on whether a request in the set of requests is currently being served by an operating system or a database, the number of other requests being currently served by resources in the interrelated chain of requests, and/or how many requests are classified as wait or async_wait. Thus, the thresholds and criteria for classifying a hang may vary from one execution flow to the next.

An execution flow may span multiple hosts, application layers, target types, and execution entities. By aggregating wait statistics along a chain in a hang graph, hangs may be analyzed at the level of an execution flow in addition or as an alternative to analyzing individual requests. For example, a hang may be detected if an aggregate wait time across an interrelated chain of requests exceeds a threshold value regardless of whether any individual requests have reached a timeout value.

In some embodiments, the thresholds are flexible and based on wait values aggregated across one or more of the dimensions such as previously described. For example, a hang may be detected if the current wait value for all requests being served by a particular database or across all databases in the system exceeds a threshold value. As another example, a hang may be detected if the current wait values for all requests being served and waited upon with a particular wait classification on a particular host exceeds a threshold value. As may be appreciated, the combination of dimensions within the hang graph that are used to detect hangs may vary. The thresholds may be exposed to and configurable by an end user or set by machine learning based on patterns learned from historical requests and hang chain graphs that are predictive of hangs.

### 5. ORPHAN REQUESTS

Generally, a source and target are linked by a common request to connect nodes. However, there may be instances of requests within a hang graph that are not reachable through traversal from a root node within a hang graph. This scenario may occur when hang management framework 136 is not able to connect requests based on detected relationships, which may lead to a disconnected hang chain. These disconnected requests are referred to herein as orphan requests.

Orphan requests may be caused by one or more of the following patterns:
A request has “not reached” the target yet, which may occur if the request information was extracted before the signal had reached the target or the target was busy processing another request and has not yet seen the new request;
A reply has “not reached” the source yet, which may occur if the request was processed by the target already, but the reply signal did not reach the source or the source is having trouble processing the reply;
A target has died, and request information is no longer able to be extracted;
A target does not support the hang management protocol and is not linked to an adaptor able to extract information on behalf of the target.

In some cases, graph generator 142 may graft disconnected nodes in the above cases when the source specifies the actual target. For example, graph generator 142 may connect node 402b to node 402d even if the target represented by node 402d is dead or unreachable if node 402b specifies the target in request R3. In other cases, the connection may not be inferred, such as if the source does not specify the target or the source of a request is not able to be determined. In these cases, an administrator may be notified of the orphan requests. Additionally or alternatively, the administrator may be presented with a hang graph, including the disconnected nodes through a GUI, which may allow the administrator to connect the nodes, trigger hang resolution operations, and/or perform other actions to address the cause of the disconnection.

In some embodiments, graph generator 142 may infer or extract attributes for a node that is grafted into a hang chain. As previously noted, a node in the hang chain may include a disconnected edge corresponding to a request to an execution entity that is not linked to an adaptor and does not support the hang management protocol. Registration attributes may be inferred for the node based on information extracted from requests corresponding to the disconnected edge. For example, the request may include the hostname, internet protocol (IP) address, and/or other attributes of a node. Graph generator 142 may extract these attributes from the request and store these in association with a new node that is grafted into the hang chain. As another example, graph generator 142 may infer a target type and/or description for the node based on the content and format of the request. Graph generator 142 may infer that a request including embedded SQL statements is directed to a database node. Other requests formats and code may be specific to operating systems or other target types. By analyzing the request, graph generator 142 may infer registration attributes for a node in the graph even if the execution entity or adaptor did not directly provide the information to hang management framework 136.

### 6. HANG RESOLUTION FRAMEWORK

When an execution flow stalls or hangs, hang management framework 136 may coordinate and/or perform one or more hang resolution operations to resolve the hang. The determination of which hang resolution operations to implement may be centralized or distributed. In the former case, hang resolution service 148 may determine which actions to perform and execute the actions. For distributed hang resolution, hang resolution service 148 may coordinate hang resolution operations with the execution entities, and individual execution entities may determine what hang resolution operations to execute, if any. The hang resolution actions may vary based on the type of request, type of resource processing the request, position of the execution entity within a hang chain, wait class of the request, and/or other factors associated with the cause of a hang.

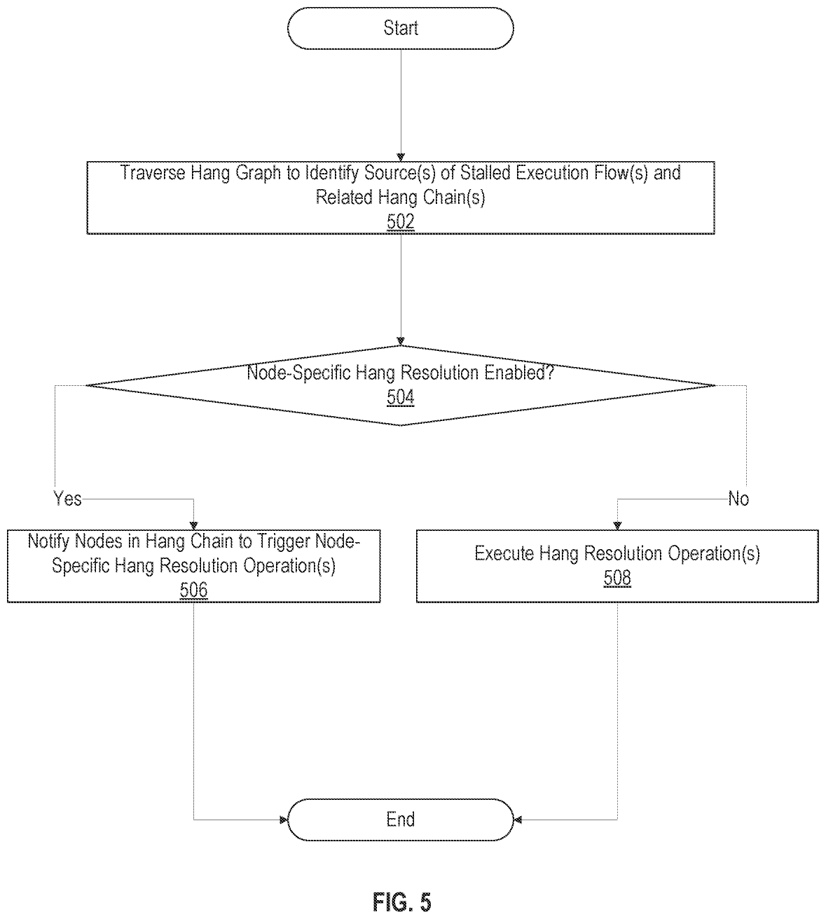

FIG. 5 illustrates an example set of operations for resolving hangs based on a hang graph in accordance with some embodiments. One or more operations illustrated in FIG. 5 may be modified, rearranged, or omitted all together. Accordingly, the particular sequence of operations illustrated in FIG. 5 should not be construed as limiting the scope of one or more embodiments.

In operation 502, hang resolution service 148 traverses a hang graph to identify one or more sources of one or more stalled execution flows and one or more related hang chains. As previously described, stalls and hangs may be detected based on wait statistics for individual requests, groups of requests, and/or execution flows. The hang chain may be identified by traversing from the source of the stall to other nodes connected in the hang graph. In some cases, a hang may affect multiple execution flows. For example, if a target has stalled serving one request, then other sources that have issued requests to the same target as part of other execution flows may be left waiting indefinitely if the hang is not quickly resolved.

In operation 504, hang resolution service 148 determines whether node-specific hang resolution is enabled. Node-specific hang resolution may be enabled and disabled on a global or node-by-node basis, depending on the particular implementation. In some embodiments, certain types of application and/or endpoints may be configured to resolve hangs using application-specific protocols. Other types of nodes may rely on hang resolution service 148 to select the appropriate hang resolution operation.

In operation 506, hang resolution service 148 notifies one or more nodes in a hang chain to trigger node-specific hang resolution operations if the nodes support node-specific hang resolution. Hang resolution service 148 may coordinate the operations between different nodes in a hang chain until the stall is resolved. For example, hang resolution service 148 may control the sequence in which nodes in a hang chain execute node-specific operations and determine whether the result of an operation has resolved a hang before proceeding to the next node in a chain.

For nodes that do not support node-specific hang resolution, in operation 508, hang resolution service 148 may execute one or more hang resolution operations on behalf of the nodes.

The hang resolution operations executed by a source or hang resolution service 148 may vary from implementation to implementation. Examples include terminating or restarting a node, retrying a request, redirecting requests from unresponsive execution entities to other execution entities, aborting an operation, installing a patch to update a node, and updating configuration settings on a node. In some embodiments, the execution entities and/or hang resolution service 148 may determine which hang resolution actions to executed based on the hang graph and/or attributes captured therein. For example, a node may determine whether to abort, retry, or redirect a request based on a wait class associated with a request, the position of the request relative to a stalled request in the hang chain, the type of request that was issued, the type of application or computing resource that is serving the request, the current wait statistics in the execution flow, and/or other attributes previously mentioned.

In some embodiments, execution entities may leverage published hang graphs to determine which node-specific resolution operations to perform. For instance, a database system that is waiting on a storage server to fulfill a request to allocate a new tablespace may be notified by the hang management system that the storage server is unresponsive. The database system may analyze the hang graph and associated attributes to determine whether to send another request to the same storage server to retry the operation, send a request to a redundant storage server to allocate the tablespace using a different server, return an error message to an upstream node in the execution flow to abort the operation, or perform one or more other node-specific hang resolution operations.

In some embodiments, execution entities and/or hang resolution service 148 may select hang resolution operations based on wait classes associated with a stalled request. For instance, a node may determine whether to retry, abort, redirect, or perform another action with respect to a request based on the wait class. Different actions may be triggered if the wait class is wait than if the wait class is async_wait.

Additionally or alternatively, different wait classes may be assigned for different types of execution entities and trigger different node-specific hang resolution operations. For example, database applications, middleware applications, web applications, and REST APIs may define different wait classes for requests being served by the different types of execution entities. Each type of execution entity may implement node-specific hang resolution logic based on the node-specific wait classes that are causing a hang.

In some embodiments, hang management framework 136 may generate incident reports to notify administrators about the source of the hang and affected execution flows. The incident report may identify automated hang resolution operations, if any, that were executed, whether the hang was resolved, how long it took to resolve the hang, the number of execution flows affected by the hang, and/or other relevant incident attributes. Hang management framework 136 may periodically send the incident reports to administrators 154 or may send reports responsive to detecting a hang.

Additionally or alternatively, hang management framework 136 may provide recommended actions to address current hangs or prevent hangs in the future. The recommendations may be based on an analysis performed on one or more hang graphs. For example, hang management framework may identify an execution entity that is commonly causing stalls across multiple hang graphs and/or execution flows. Hang management framework 136 may recommend upgrading the node, such as by applying patches or switching to a newer version of the product, replacing the node, expanding system capacity by adding additional nodes, and/or other actions predicted to optimize system performance.

### 7. COMPUTER NETWORKS AND CLOUD NETWORKS

In some embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In some embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In some embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In some embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In some embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In some embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In some embodiments, in a multi-tenant computer network, tenant isolation is implemented to ensure that the applications and/or data of different tenants are not shared with each other. Various tenant isolation approaches may be used.

In some embodiments, each tenant is associated with a tenant ID. Each network resource of the multi-tenant computer network is tagged with a tenant ID. A tenant is permitted access to a particular network resource only if the tenant and the particular network resources are associated with a same tenant ID.

In some embodiments, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In some embodiments, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In some embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

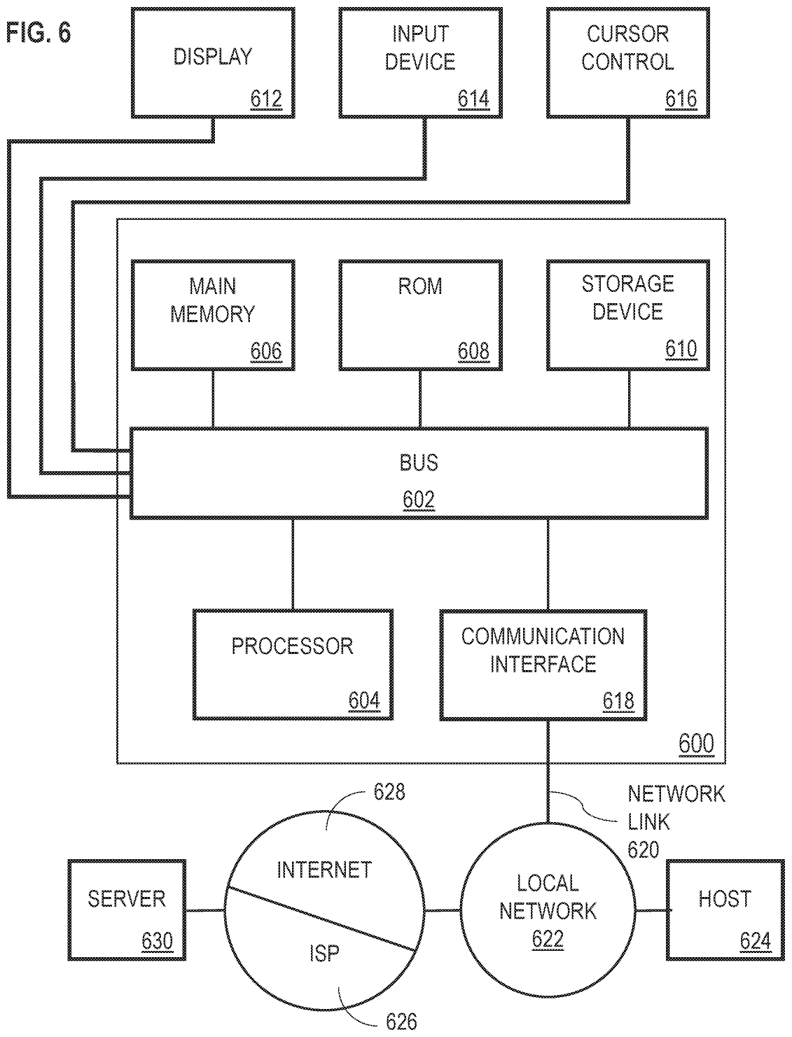

For example, FIG. 6 shows a block diagram that illustrates a computer system in accordance with some embodiments. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 9. MISCELLANEOUS; EXTENSIONS

Embodiments are directed to a system with one or more devices that include a hardware processor and that are configured to perform any of the operations described herein and/or recited in any of the claims below.

In some embodiments, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause:
receiving, from a plurality of nodes in a distributed computing environment, a first set of information identifying a first set of requests being served within the distributed computing environment and a second set of information identifying a second set of requests on which at least one node of the plurality of nodes in the distributed computing environment is waiting;
identifying, based at least in part on the first set of information and the second set of information: (a) a chain of interrelated requests that includes at least a first request in the first set of requests and a second request in the second set of requests, and (b) a source that is causing a hang in the chain of interrelated requests, wherein the source is a particular type of computing resource and the chain of interrelated requests include links between different types of computing resources within the distributed computing environment; and
performing at least one operation based at least in part on identifying the source and the particular type of computing resource that is causing the hang in the chain of interrelated requests.

2. The media of claim 1, wherein the instructions further cause: generating a graph based at least in part on the first set of information and the second set of information; wherein the graph connects nodes based at least in part on which nodes are sources and which nodes are targets of the second set of requests, wherein at least a first node and a second node in the graph correspond to different types of computing resources within the distributed computing environment.

3. The media of claim 1, wherein identifying the source that is causing a hang in the chain of interrelated requests comprises identifying a disconnected request in the chain of interrelated requests.

4. The media of claim 1, wherein performing the at least one operation comprises sending a notification to at least one node of the plurality of nodes; wherein the at least one node performs at least one action to address the hang responsive to receiving the notification.

5. The media of claim 4, wherein the node implements node-specific logic to address the hang.

6. The media of claim 1, wherein performing the at least one operation comprises publishing the chain of interrelated requests to the plurality of nodes.

7. The media of claim 1, wherein performing the at least one operation comprises stopping request processing by at least one node of the plurality of nodes.

8. The media of claim 1, wherein the instructions further cause: receiving requests from at least a subset of the plurality of nodes to register with a service for performing hang management within the distributed computing environment; responsive to receiving the requests, registering at least the subset of the plurality of nodes; and responsive to registering at least the subset of the plurality of nodes, periodically retrieving request information from at least the subset of the plurality of nodes.

9. The media of claim 1, wherein the instructions further cause: identifying a subset of the plurality of nodes that do not implement a protocol for communicating with the service for performing hang management; and configuring at least one adaptor to periodically translate request information originating from the subset of the plurality of nodes.

10. A method comprising:
receiving, from a plurality of nodes in a distributed computing environment, a first set of information identifying a first set of requests being served within the distributed computing environment and a second set of information identifying a second set of requests on which at least one node of the plurality of nodes in the distributed computing environment is waiting;
identifying, based at least in part on the first set of information and the second set of information: (a) a chain of interrelated requests that includes at least a first request in the first set of requests and a second request in the second set of requests, and (b) a source that is causing a hang in the chain of interrelated requests, wherein the source is a particular type of computing resource and the chain of interrelated requests include links between different types of computing resources within the distributed computing environment; and
performing at least one operation based at least in part on identifying the source and the particular type of computing resource that is causing the hang in the chain of interrelated requests.

11. The method of claim 10, further comprising: generating a graph based at least in part on the first set of information and the second set of information; wherein the graph connects nodes based at least in part on which nodes are sources and which nodes are targets of the second set of requests, wherein at least a first node and a second node in the graph correspond to different types of computing resources within the distributed computing environment.

12. The method of claim 10, wherein identifying the source that is causing a hang in the chain of interrelated requests comprises identifying a disconnected request in the chain of interrelated requests.

13. The method of claim 10, wherein performing the at least one operation comprises sending a notification to at least one node of the plurality of nodes; wherein the at least one node performs at least one action to address the hang responsive to receiving the notification.

14. The method of claim 13, wherein the node implements node-specific logic to address the hang.

15. The method of claim 10, wherein performing the at least one operation comprises publishing the chain of interrelated requests to the plurality of nodes.

16. The method of claim 10, wherein performing the at least one operation comprises stopping request processing by at least one node of the plurality of nodes.

17. The method of claim 10, further comprising: receiving requests from at least a subset of the plurality of nodes to register with a service for performing hang management within the distributed computing environment; responsive to receiving the requests, registering at least the subset of the plurality of nodes; and responsive to registering at least the subset of the plurality of nodes, periodically retrieving request information from at least the subset of the plurality of nodes.

18. The method of claim 10, further comprising: identifying a subset of the plurality of nodes that do not implement a protocol for communicating with the service for performing hang management; and configuring at least one adaptor to periodically translate request information originating from the subset of the plurality of nodes.

19. A system comprising:
one or more hardware processors;
one or more non-transitory computer-readable media storing instructions which, when executed by the one or more hardware processors, cause:
receiving, from a plurality of nodes in a distributed computing environment, a first set of information identifying a first set of requests being served within the distributed computing environment and a second set of information identifying a second set of requests on which at least one node of the plurality of nodes in the distributed computing environment is waiting;
identifying, based at least in part on the first set of information and the second set of information: (a) a chain of interrelated requests that includes at least a first request in the first set of requests and a second request in the second set of requests, and (b) a source that is causing a hang in the chain of interrelated requests, wherein the source is a particular type of computing resource and the chain of interrelated requests include links between different types of computing resources within the distributed computing environment; and
performing at least one operation based at least in part on identifying the source and the particular type of computing resource that is causing the hang in the chain of interrelated requests.

20. The system of claim 19, wherein the instructions further cause: generating a graph based at least in part on the first set of information and the second set of information; wherein the graph connects nodes based at least in part on which nodes are sources and which nodes are targets of the second set of requests, wherein at least a first node and a second node in the graph correspond to different types of computing resources within the distributed computing environment.
